(19) United States
(12) Patent Application Publication
(10) Pub. No.: US 2017/0234457 A1
(43) Pub. Date: Aug. 17, 2017

(54) SYSTEMS AND METHODS FOR CONSTRUCTING, SUPPORTING, AND MAINTAINING AN ELEVATED PIPELINE

(71) Applicant: Fluor Technologies Corporation, Sugar Land, TX (US)

(72) Inventors: Alan T. Sayler, Deer Park, TX (US); Cecil G. Roberts, Richmond, TX (US)

(21) Appl. No.: 15/044,193

(22) Filed: Feb. 16, 2016

(51) Int. Cl. F16L 1/06; F16L 3/223; F16L 1/024

(52) U.S. Cl. CPC F16L 1/06; F16L 1/0246; F16L 3/2235

(57) ABSTRACT

A support assembly and methods relating thereto is disclosed for supporting a pipeline at a height above the ground. In an embodiment, the support assembly has a central axis and includes a vertical pile assembly configured to be coupled to the ground. In addition, the support assembly includes an upper support member coupled to the vertical pile assembly. The upper support member includes a support surface that is configured to support one or more pipelines. The vertical pile assembly is configured to transition between a retracted position, wherein the support surface is disposed at a height H1 measured axially from the ground, and an extended position, wherein the support surface is disposed at a height H2 measured axially from the ground that is greater than the height H1.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure generally relates to pipelines for flowing fluids between two or more points. More particularly, this disclosure relates to elevated pipelines and support assemblies for supporting the elevated pipeline above the ground.

Above ground pipelines are sometimes elevated above grade to promote wildlife migration, span low areas, and for other reasons. Typically, elevated pipelines are constructed by installing one or more vertical piles into the ground, mounting support members (or structures) on the upper ends of the vertical piles at the desired elevation of the pipeline, and then lifting and placing the pipeline segments onto the elevated support members. Thereafter, the new pipeline segments are coupled to each other to form a continuous flow path therethrough.

### BRIEF SUMMARY OF THE DISCLOSURE

Some embodiments disclosed herein are directed to a support assembly for supporting a pipeline at a height above the ground, the support assembly having a central axis. In an embodiment, the support assembly includes a vertical pile assembly configured to be coupled to the ground. In addition, the support assembly includes an upper support member coupled to the vertical pile assembly. The upper support member includes a support surface that is configured to support one or more pipelines. The vertical pile assembly is configured to transition between a retracted position, wherein the support surface is disposed at a height H1 measured axially from the ground, and an extended position, wherein the support surface is disposed at a height H2 measured axially from the ground that is greater than the height H1.

Other embodiments disclosed herein are directed to a piping system. In an embodiment, the piping system includes a pipeline including a continuous flow path configured to receive and flow a fluid therethrough. In addition, the piping system includes a plurality of support assemblies coupled to the pipeline and configured to support the pipeline at a height above the ground. Each support assembly includes a central axis and a vertical pile assembly coupled to the ground. In addition, each support assembly includes an upper support member coupled to the vertical pile assembly. The upper support member includes a support surface that is configured to support the pipeline. The vertical pile assembly is configured to transition between a retracted position, wherein the support surface is disposed at a height H1 measured axially from the ground, and an extended position, wherein the support surface is disposed at a height H2 measured axially from the ground that is greater than the height H1.

Still other embodiments are directed to a method for installing an elevated pipeline at a desired height above the ground. In an embodiment, the method includes (a) coupling a vertical pile assembly to the ground, the vertical pile assembly extending along a central axis and being configured for extension along the central axis. In addition, the method includes (b) coupling an upper support member to the vertical pile assembly, the upper support member including a support surface. Further, the method includes (c) supporting a conduit segment of the pipeline on the support surface. Still further, the method includes (d) extending the vertical pile assembly along the axis after (c).

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic side view of a piping system for flowing a fluid between two or more points in accordance with at least some embodiments;

FIG. 2 is a perspective view of one of the support assemblies of the piping system of FIG. 1;

FIG. 3 is a side, partial cross-sectional view of the support assembly of FIG. 2;

FIGS. 4 and 5 are sequential side views of the support assembly of FIG. 2 transitioning from a retracted position to an extended position;

FIG. 6 is a schematic side view of the support assembly of FIG. 2 being transitioned from the retracted position to the extended position with a pair of jacks;

FIG. 7 is a schematic side view of the support assembly of FIG. 2 being transitioned from the retracted position to the extended position with a lifting device;

FIG. 8 is a perspective view of another embodiment of a support assembly for use with the piping system of FIG. 1;

FIG. 9 is a side, partial cross-sectional view of the support assembly of FIG. 8;

FIG. 10 is a perspective view of another embodiment of a support assembly for use with the piping system of FIG. 1;

FIG. 11 is a side, partial cross-sectional view of the support assembly of FIG. 10;

FIG. 12 is an enlarged perspective view of a ratcheting pin assembly of the support assembly of FIG. 10;

FIG. 13 is a side, cross-sectional view of an embodiment of one of the ratcheting pins and recesses of the ratcheting pin assembly of the support assembly of FIG. 10;

FIG. 14 is a side, cross-sectional view of another embodiment of one of the ratcheting pins and recesses of the ratcheting pin assembly of the support assembly of FIG. 10; and

FIG. 15 is a flow diagram of a method for elevating a pipeline above the ground in accordance with the embodiments disclosed herein.

### DETAILED DESCRIPTION OF EXEMPLARY EMBODIMENTS

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. As used herein, the terms “telescope,” “telescopically,” and “telescoping” refer to the relative extension or retraction of two or more members either along a common axis or parallel axes, regardless of whether or not the two or more members are disposed within one another (concentrically or otherwise).

As previously described, in constructing an elevated pipeline, vertical piles are installed in the ground, support members (or structures) are then mounted at the upper ends of the vertical piles at the desired elevation of the pipeline, and then the pipeline segments are lifted and placed on the elevated support members and coupled together to form the completed pipeline. However, the lifting required to initially raise and place the pipeline segments on the elevated support members can be difficult and dangerous. These difficulties are exacerbated as the desired height of the pipeline increases. Thus, embodiments disclosed herein include support assemblies for supporting an elevated pipeline at a desired height above the ground that may be selectively transitioned between a retracted position to an extended position to raise and lower the pipeline (or pipeline segment) as desired. Thus, as will be described in more detail below, through use of a support assembly as described herein, much of the initial lifting and mounting for the individual pipeline segments may be performed at or very near the ground, such that the costs and dangers of constructing and maintaining an elevated pipeline may be reduced. In addition, because much of the initial lifting and mounting of the pipeline segments can be carried out at greatly reduced heights, the number and size of lifting devices required for the construction and/or maintenance of the elevated pipeline may be reduced.

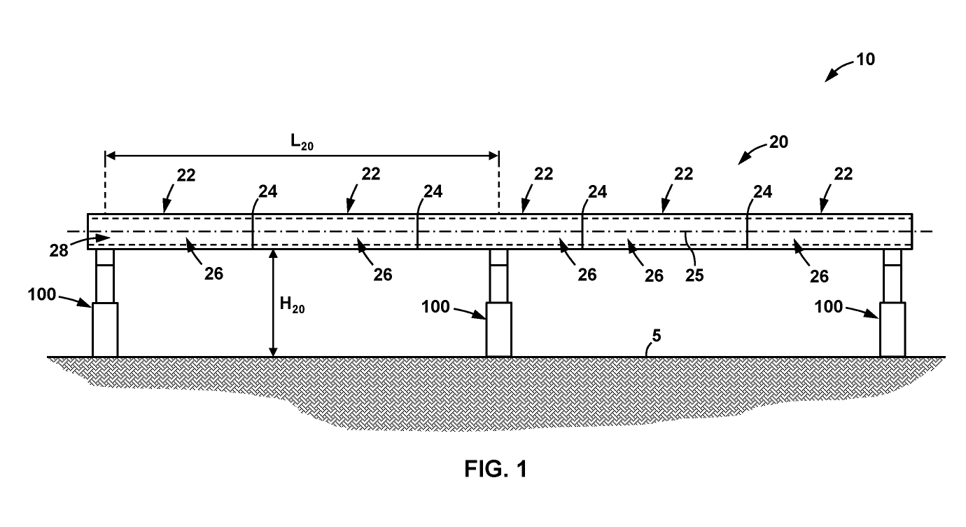

Referring now to FIG. 1, a piping system 10 for flowing a fluid between two or more points is shown. Piping system 10 includes at least one pipeline 20 that may comprise any conduit suitable for routing a fluid or fluids between two or more points (e.g., pipe, hose, tube, etc.). In this embodiment, pipeline 20 comprises a plurality of conduit segments 22 connected end-to-end along a common longitudinal axis 25 at a plurality of connection points 24. Each conduit segment 22 includes a throughbore 26 extending therethrough that is aligned with the throughbores 26 of the axially adjacent conduit segments 22 along axis 25 to thereby form a continuous flow path 28 within pipeline 20 that receives and routes one or more fluids during operation.

As shown in FIG. 1, pipeline 20 is supported or suspended above the ground or grade 5 at a height H₂₀ by a plurality of support assemblies 100. In FIG. 1, each of the support assemblies 100 are shown in an extended position where the height H₂₀ may range from 8 to 24 feet depending on various factors, such as, for example, the elevation (or change thereof) in ground 5, the height required for local wildlife to traverse under pipeline 20, the height of any other obstructions (e.g., other pipelines, buildings, etc.) in the path of pipeline 20, etc. As will be described in more detail below, support assemblies 100 may each also be placed in a retracted position, where height H₂₀ is reduced (e.g., from the extended position of FIG. 1) and pipeline 20 is disposed relatively close to ground 5. For example, in some embodiments, when the support assemblies 100 are in the retracted position, height H₂₀ may range from 2 to 6 feet.

Support assemblies 100 are spaced along pipeline 20 such that each assembly 100 is axially separated from each immediately adjacent assembly 100 by a span length L₂₀ (or more simply span L₂₀). In some embodiments, span L₂₀ ranges from 40 to 60 feet and in this embodiment is approximately 55 feet. However, span L₂₀ may be other values (e.g., below 40 feet and/or above 60 feet) in other embodiments. Also, while each span L₂₀ is shown to be substantially equal in the embodiment of FIG. 1, it should be appreciated that span L₂₀ may range along pipeline 20 depending on shape, contours, and/or conditions of the supporting ground 5 (e.g., elevation changes, soil composition, obstacles, etc.).

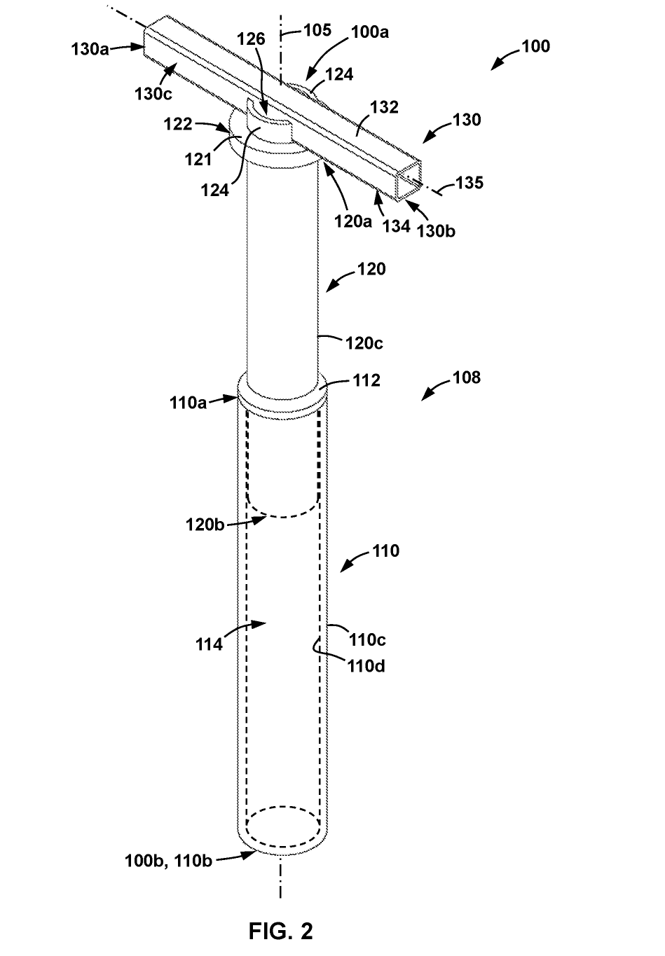

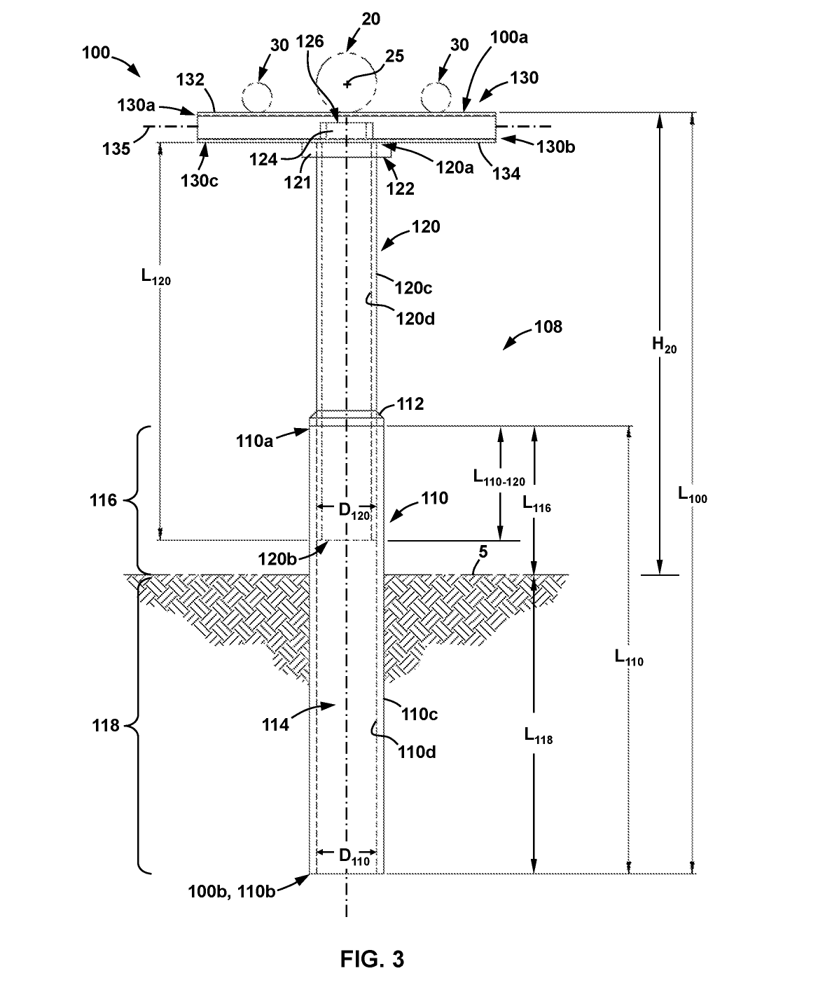

Referring now to FIGS. 2 and 3, one of the support assemblies 100 for supporting pipeline 20 at an elevated height H₂₀ (e.g., the elevated height H₂₀ achieved when the support assemblies 100 are in the extended position as shown in FIG. 1) is shown, it being understood that each of the other assemblies 100 are typically configured the same. Support assembly 100 includes a central or longitudinal axis 105, a first or upper end 100a, and a second or lower end 100b opposite upper end 100a. As is best shown in FIG. 3, support assembly 100 also includes a total length L₁₀₀ that extends axially along axis 105 between ends 100a, 100b. As is evident from FIG. 3, the length L₁₀₀ of support assembly 100 (along with the length of the support assembly 100 that is disposed within the ground 5—e.g., see length L₁₁₈ shown in FIG. 3 and discussed below) determines the height H₂₀ of pipeline 20 during operations. To this point, support assembly 100 has been described as supporting only a single pipeline 20; however, it should be appreciated that support assemblies 100 may support more than one pipeline during operations. Thus, to illustrate this functionality, FIG. 3 shows support assembly 100 supporting pipeline 20 shown in FIG. 1 and two additional pipelines 30 that extend parallel to pipeline 20. Pipelines 30 are configured substantially the same as pipeline 20 (except that pipelines 30 are shown to be smaller in size than pipeline 20), and thus, a detailed description of the specific structure of pipelines 30 is omitted in the interests of brevity.

Referring still to FIGS. 2 and 3, support assembly 100 includes a vertical pile assembly 108 that further includes a first or outer support member or pile 110 and a second or inner support member or pile 120 at least partially coaxially disposed within outer support member 110 along axis 105 so that inner support member 120 is configured to slide axially within the outer support member 110. Outer support member 110 is a tubular member that includes a first or upper end 110a, a second or lower end 110b opposite upper end 110a, a radially outer surface 110c extending axially between ends 110a, 110b, and a radially inner surface 110d also extending axially between ends 110a, 110b (such that outer support member 110 is hollow for at least a portion of its length). Lower end 110b is coincident with lower end 100b of support assembly 100. In addition, in this embodiment, radially outer surface 110c and radially inner surface 110d are each cylindrical surfaces such that radially inner surface 110d defines a cylindrical recess or throughbore 114 extending axially between ends 110a, 110b along axis 105. As is best shown in FIG. 3, throughbore 114 includes an inner diameter D₁₁₀ that typically is slightly larger than the outer diameter of the inner support member 120 (i.e., diameter D₁₂₀ discussed below). For example, in some embodiment, the inner diameter D₁₁₀ of outer support member 110 ranges from 20 to 36 inches. As is also best shown in FIG. 3, outer support member 110 also includes a total axial length L₁₁₀ extending axially between ends 110a, 110b along axis 105. In some embodiments, length L₁₁₀ may range from 16 to 20 feet.

Inner support member 120 is a tubular member that includes a first or upper end 120a, a second or lower end 120b opposite upper end 120a, a radially outer surface 120c extending axially between ends 120a, 120b, and optionally a radially inner surface 120d also extending axially between ends 120a, 120b (radially inner surface 120d is designated as “optional” because in some embodiments, inner support member 120 may be solid). As with outer support member 110, radially outer surface 120c and radially inner surface 120d of inner support member 120 are cylindrical surfaces. As is best shown in FIG. 3, radially outer surface 120c includes an outer diameter D₁₂₀ that is slightly smaller than inner diameter D₁₁₀ of outer support member 110. In some embodiments, outer diameter D₁₂₀ of inner support member 120 is approximately ⅛ to ¼ of an inch less than the inner diameter D₁₁₀ of outer support member 110. As is also best shown in FIG. 3, inner support member 120 also includes a total axial length L₁₂₀ extending between ends 120a, 120b. In some embodiments, length L₁₂₀ may range from 2 to 15 feet.

A mounting bracket 122 is secured to upper end 120a of inner support member 120.

Mounting bracket 122 generally includes a support flange 121, and a pair of vertical supports 124 extending axially from support flange 121. Vertical supports 124 are radially opposite one another across axis 105 (i.e., supports 124 are angularly spaced 180° from one another about axis 105) such that supports 124 define a recess 126 therebetween. Mounting bracket 122 may be secured to upper end 120a of inner support member 120 in any suitable manner such as, for example, welding, bolts, adhesive, etc.

Referring still to FIGS. 2 and 3, support assembly 100 also includes an upper support member 130 (which is typically oriented horizontally) that is secured to the vertical pile assembly 108, typically by secure attachment to mounting bracket 122 on upper end 120a of inner support member 120. In this embodiment, upper support member 130 is an elongate member that includes a central axis 135, a first end 130a, a second end 130b opposite the first end 130a, and an outer surface 130c (e.g., a radially outer surface) extending axially between ends 130a, 130b along axis 135. Axis 135 extends substantially perpendicularly or orthogonally to axis 105 (or a projection of axis 105) when upper support member 130 is coupled to upper end 120a of inner support member 120; however, such alignment is not required. Radially outer surface 130c includes an upper support surface 132 and a lower support surface 134 radially opposite upper support surface 132 about axis 135 (i.e., surfaces 132, 134 are angularly spaced 180° from one another about axis 135). Upper support member 130 is received within recess 126 between the support members 124 such that lower support surface 134 abuts or engages with support flange 121 and upper support surface 132 defines an uppermost surface of support assembly 100 at upper end 100a. Thus, in this embodiment the length L₁₀₀ of support assembly 100 extends axially (along axis 105) from upper support surface 132 to lower end 110b of outer support member 110. In addition, as shown in FIG. 3, the height H₂₀ extends axially with respect to axis 105 between ground 5 and upper support surface 132. Upper support member 130 may be secured to mounting bracket 122 in any suitable manner, such as, for example, welding, bolts, rivets, adhesive, etc.

Referring specifically to FIG. 3, during operations, upper support surface 132 engages and supports pipelines 20, 30 above the ground 5 (e.g., at height H₂₀). In this embodiment, upper support surface 132 is a planar surface extending parallel to axis 135; however, in other embodiments, support surface 132 may include a suitable curvature (e.g., cylindrical curvature) to more securely receive and engage with the outer surface of pipeline 20 (and/or pipelines 30). In addition, in other embodiments, one or more saddles or other support structures may be secured to upper support surface 132 to receive and engage with the pipelines 20, 30 during operations. The saddles may be cylindrically curved to correspond with the curved outer surface of the corresponding pipeline (e.g., pipelines 20, 30).

Referring specifically to FIG. 3, during operations, outer support member 110 is embedded within the ground 5 and secured therein through any suitable method or technique. For example, in environments where there is permafrost below the surface of ground 5, outer support member 110 may be inserted within an oversized hole formed in the ground 5. Thereafter, a sand and slurry mixture is added between the radially outer surface 110c of outer member 110 and the hole that is then allowed to freeze in place to secure outer member 110 within the ground 5. In other embodiments, concrete may be disposed between radially outer surface 110c of outer member 110 and the hole in the ground 5. In still other embodiments, outer member 110 may be simply driven into the ground 5 such that outer member 110 is secured in place through a friction fit.

Regardless of the method used to insert and secure outer support member 110 within the ground 5, once support member 110 is installed and secured therein, outer support member 110 is separated into an upper section or projection 116 extending upward from ground 5, and a lower section or embedment 118 extending into the ground 5. Projection 116 includes an axial length L₁₁₆ extending axially along axis 105 between ground 5 and upper end 110a and embedment 118 includes an axial length L₁₁₈ extending axially along axis 105 between ground 5 and lower end 110b. The lengths L₁₁₆, L₁₁₈ together equal the total length L₁₁₀ of outer support member 110 (i.e., L₁₁₆+L₁₁₈=L₁₁₀). In addition, in at least some embodiments, the length L₁₁₆ of projection 116 is smaller than the length L₁₁₈ of the embedment 118. For example, in some embodiments, the length L₁₁₆ equals approximately 20% of the length L₁₁₀, and the length L₁₁₈ of embedment 118 equals approximately 80% of the length L₁₁₀. In addition, in some embodiments, the length L₁₁₆ ranges from 2 to 6 feet, and the length L₁₁₈ ranges from 15 to 30 feet.

In addition, referring again to FIGS. 2 and 3, during operations, lower end 120b of inner support member 120 is inserted within throughbore 114 of outer support member 110 along axis 105 such that radially outer surface 120c of inner support member 120 slidingly engages with radially inner surface 110d of outer support member 110. Thus, inner support member 120 may telescopically extend from and retract within throughbore 114 of outer support member 110 during operations to adjust the length L₁₀₀ of support assembly 100 and the vertical position of upper support surface 132 of support member 130 relative to the ground 5 (i.e., to adjust height H₂₀). It should be appreciated that lower end 120b of inner support member 120 may be inserted within throughbore 114 of outer support member 110 either before or after outer support member 110 is inserted and secured within the ground 5. It should also be appreciated that telescopic extension/retraction of vertical pile assembly 108 may be selective, for example, only occurring when the inner support member 120 is not secured or fixed to the outer support member 110. Further, as shown in FIG. 3, when inner support member 120 is inserted within throughbore 114 of outer support member 120, members 110, 120 overlap one another over an axial distance or length L₁₁₀₋₁₂₀ which may range from 2 feet at a low end (e.g., when the inner support member 120 is fully extended from throughbore 114 of outer support member 110) to 8 feet or more at a high end (e.g., when the inner support member is fully retracted within throughbore 114 of outer support member 110). In some embodiments, when vertical pile assembly 108 is in the retracted position, the length L₁₁₀₋₁₂₀ may substantially equal the length L₁₂₀ of inner support member 120.

In this embodiment, to fix the relative positions of support members 110, 120 (e.g., to fix the length L₁₀₀ of assembly 100 and/or to fix the height H₂₀ of pipeline 20) a weld or junction 112 may be formed between upper end 110a of outer support member 110 and radially outer surface 120c of inner support member 120. For example, weld 112 may be a corner joint weld that extends between upper end 110a and radially outer surface 120c and extends annularly with respect to axis 105. Weld 112 may be formed through any suitable welding technique. Other embodiments may use alternative fixing means, methods, or devices, examples of which are discussed herein.

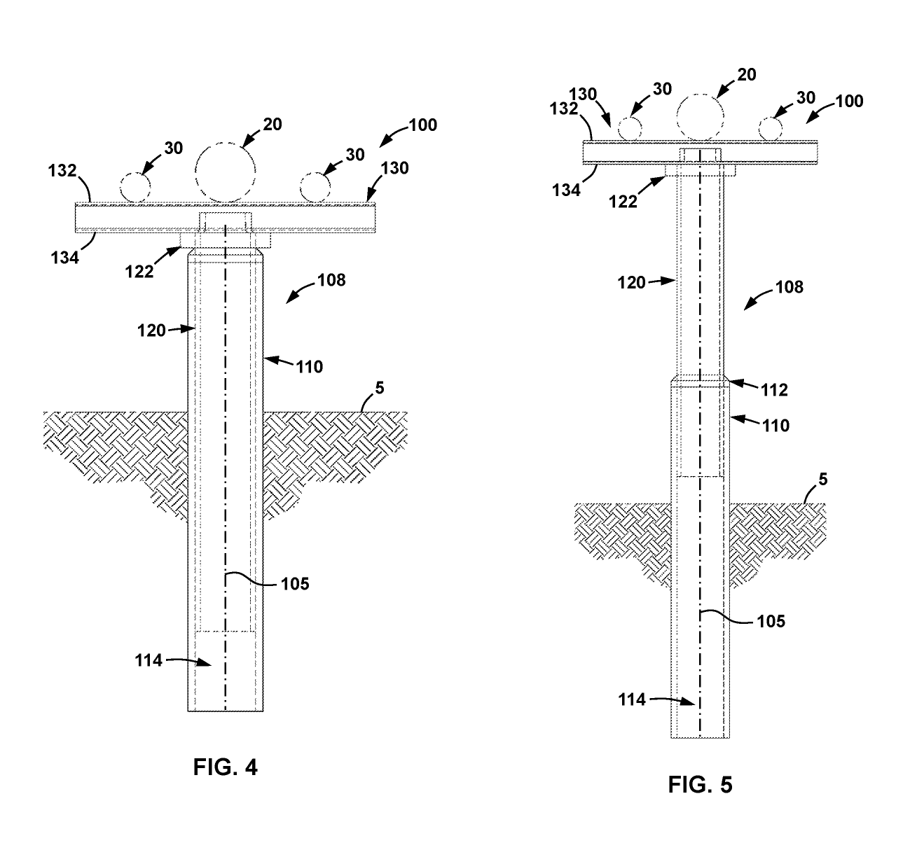

Referring now to FIGS. 4 and 5, during operation, after inner support member 120 is inserted axially within outer support member 110 and pipelines 20 and/or 30 (or at least a segment portion thereof) are disposed on upper support surface 132 of upper support member 130, inner support member 120 may be raised related to outer support member 110 such that pipelines 20, 30 and upper support member 130 are elevated above ground 5 to the desired height (e.g., height H₂₀). Specifically, referring to FIG. 4, initially, vertical pile assembly 108 of support assembly 100 is placed in a first or retracted position where inner support member 120 is retracted within throughbore 114 and upper support member 130 is relatively close to the ground 5 (e.g., with 5 to 8 feet in some embodiments). This shortened height allows personnel to more easily and safely raise and install pipelines 20, 30 (or one or more conduit segments—e.g., segments 22—of pipelines 20, 30) onto upper support member 130. Referring specifically now to FIG. 5, once pipelines 20, 30 (or one or more conduit segments thereof) are installed and secured on upper support member 130 (e.g., on surface 132 or within a saddle), the vertical pile assembly 108 is transitioned from the retracted position (FIG. 4) to an extended position (FIG. 5) where the inner support member 120 is axially extended from throughbore 114 in outer support member 110 to place pipelines 20, 30 at the desired height H₂₀. Thus, transitioning the vertical pile assembly from the retracted position shown in FIG. 4 to the extended position shown in FIG. 5 increases both the length L₁₀₀ of support assembly 100 and the height H₂₀ between the ground 5 and the support surface 132 (and therefore the pipelines 20, 30). Conversely, transitioning the vertical pile assembly 108 from the extended position shown in FIG. 5 to the retracted position shown in FIG. 4 decreases both the length L₁₀₀ of support assembly 100 and the height H₂₀. In some embodiments, if only one or more segments (e.g., segments 22) of the pipelines 20, 30 are installed on upper support member 130 when vertical pile assembly 108 of support assembly 100 is in the retracted position (FIG. 4), then the axial ends of the conduit segments are coupled to the axial ends of the adjacent conduit segments that were previously installed along the corresponding pipeline 20, 30 after the vertical pile assembly 108 is transitioned to the extended position (FIG. 5).

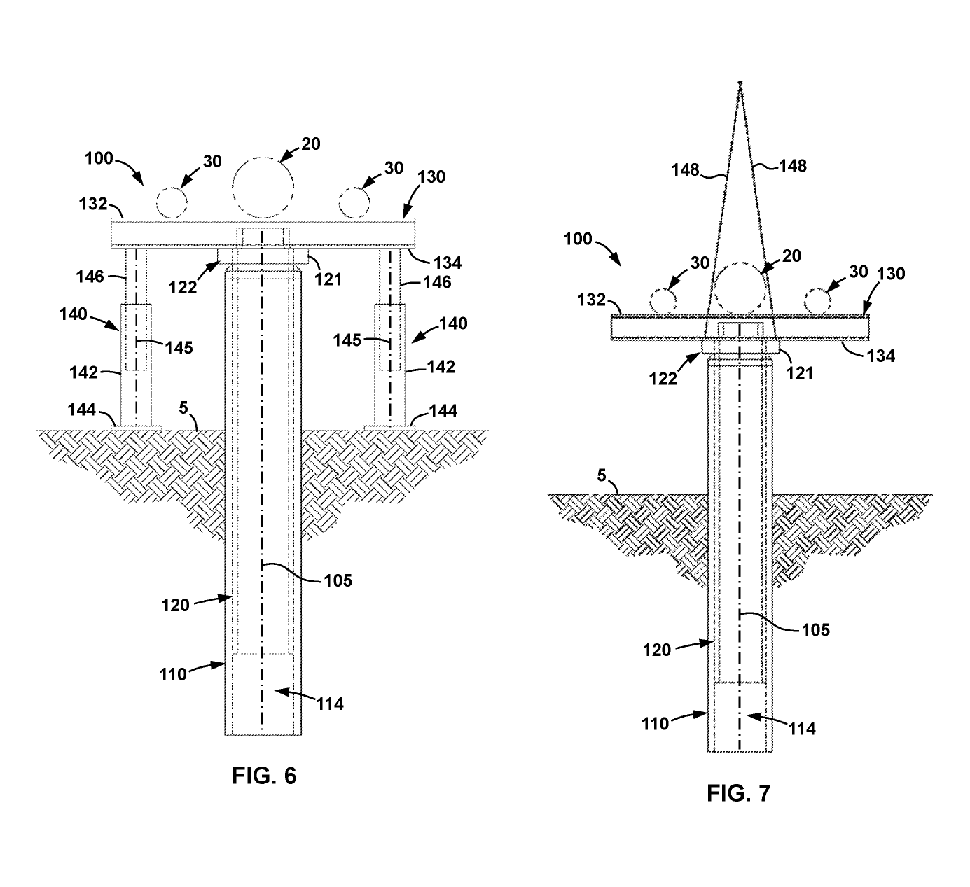

Any suitable technique may be used to raise inner member 120, upper support member 130, and pipelines 20, 30. For example, referring now to FIG. 6, in some embodiments, one or more jacks 140 may be utilized to lift inner member 120, upper support member 130, and pipelines 20, 30 above ground 5. Jacks 140 each include a central or longitudinal axis 145, an outer tubular housing 142, and a movable plunger 146 extending axially from housing 142 along axis 145. A foot or engagement flange 144 is coupled to one end of housing 142, and plunger 146 is inserted with the axially opposite end of housing 142. Plunger 146 may be axially extended from and retracted into housing 142 through any suitable method, such as, for example, hydraulic power, pneumatic power, electrical power, an internal ratcheting system, etc. During operations, each jack 140 is placed relative to support assembly 100 such that foot 144 is engaged with ground 5, axis 145 is oriented generally parallel to and radially offset to axis 105, and plunger 146 is extended from housing 142 to bear against lower surface 134 of upper support member 130. Thereafter, subsequent extension of plunger 146 from housing 142 (e.g., via hydraulic, pneumatic, electrical, mechanical power, etc.) forces upper support member 130 and thus, pipelines 20, 30 and inner support member 120 vertically upward along axis 105 relative to outer support member 110 (which is embedded in ground 5 as previously described above). The specific position of the one of more jacks 140 may vary, depending on the specific embodiment, (and in some embodiments, a jack—e.g. jack 140—may be located within the outer support member 110 and/or the inner support member 120).

Referring now to FIG. 7, in other embodiments, a crane or other suitable lifting device (not shown) is used to lift pipelines 20, 30, upper support member 130, and inner support member 120 relative to outer support member 110 during operations. Specifically, in these embodiments, one or more cables or lines 148 are coupled to support flange 121 of mounting bracket 122 (or alternatively to the upper support member 130) and to the attachment point (not shown) of the crane or other lifting device. Thereafter, the crane or other lifting device places sufficient tension on the lines 148 to raise upper support member 130 and thus, pipelines 20, 30 and inner support member 120 vertically upward along axis 105 relative to outer support member 110. The crane or lifting device is not specifically shown in FIG. 7 since one of ordinary skill would know of various examples of a suitable lifting device, and the specific form or design of the lifting device may be greatly varied. It should be noted that typically such lifting occurs after securement of the pipelines (e.g., pipelines 20, 30) in place atop the support assembly 100.

Referring again to FIGS. 4 and 5, regardless of the method used to transition vertical pile assembly 108 from the retracted position (FIG. 4) to the extended position (FIG. 5) and thereby elevate pipelines 20, 30, to the desired height H₂₀, once the desired height H₂₀ is achieved, the position of inner support member 120 is fixed relative to the position of outer support member 110 via the weld 112 as previously described.

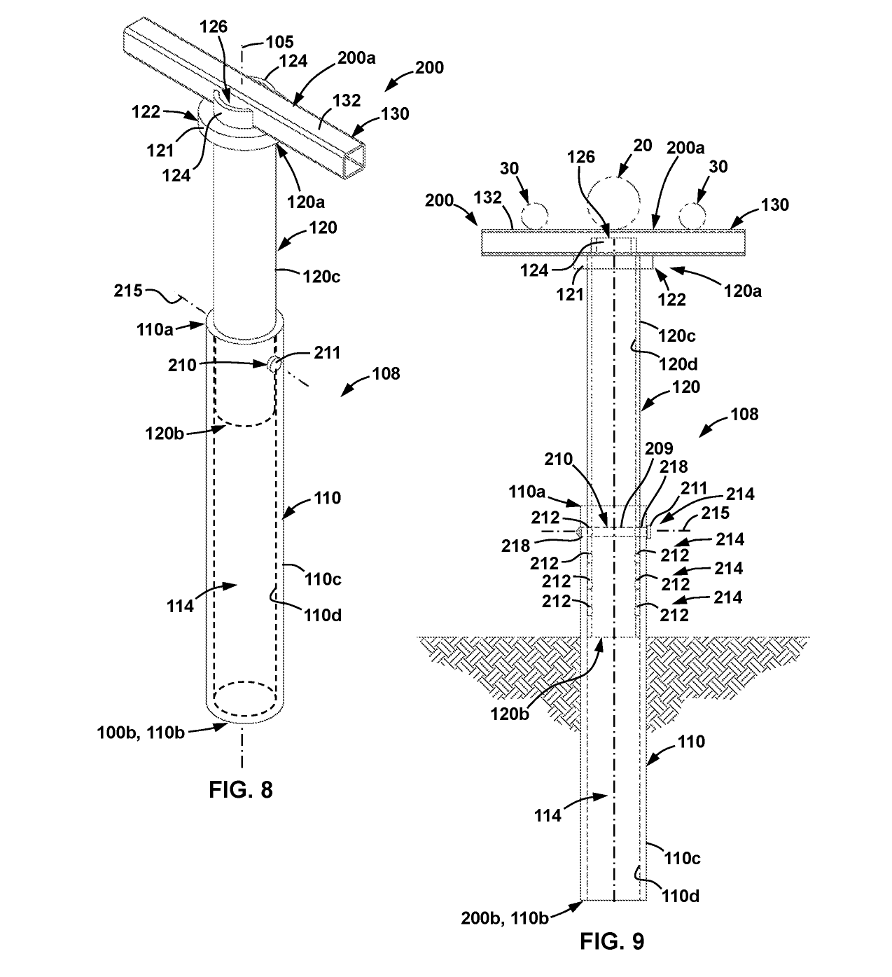

Referring now to FIGS. 8 and 9, another embodiment of support assembly 200 for supporting pipeline 20 at height H₂₀ (see FIG. 1) is shown. Support assembly 200 is substantially the same as support assembly 100, previously described, and thus, shared components between the support assemblies 100, 200 will be labeled with the same reference numerals, and the description below will concentrate on the differences of support assembly 200 relative to support assembly 100. In particular, support assembly 200 includes the central axis 105, a first or upper end 200a, a second or lower end 200b opposite upper end 200a, the vertical pile assembly 108, and upper support member 130. In addition, vertical pile assembly 108 may be transitioned between the retracted and extended positions shown in FIGS. 4 and 5 to raise and/or lower pipelines 20, 30 (or conduit segments thereof) relative to ground 5 as previously described.

In this embodiment, support assembly 200 does not include the weld or junction 112 to fix axial position of inner support member 120 relative to outer support member 110 when the support assembly 200 is placed in the extended position (e.g., see FIG. 5). Rather, support assembly 200 includes a pin 210 that is inserted through aligned radial apertures in support members 110, 120 to fix the position of inner support member 120 relative to the position of outer support member 110. Specifically, as best shown in FIG. 9, inner support member 120 includes one or more and typically a plurality of apertures 212 extending radially between the radially outer surface 120c and the radially inner surface 120d with respect to axis 105. Apertures 212 may be arranged in a plurality of axially spaced rows 214, each row including a total of two (2) apertures 212 that are radially opposite one another about axis 105 (i.e., apertures 212 of each row 214 are angularly spaced 180° apart from one another). Outer support member 110 also includes one or more corresponding apertures (typically a pair of apertures 218) extending radially between the radially outer surface 110c and the radially inner surface 110d. Each of the apertures 218 are disposed radially opposite one another about axis 105 (i.e., apertures 218 are angularly spaced 180° from one another about axis 105), and are each disposed proximate the upper end 110a of outer support member 110. Typically, corresponding apertures in the inner and outer support members 120, 110, respectively, would be of approximately the same size and shape.

Pin 210 is an elongate member that typically includes a head 211 and a cylindrical body 209 extending from head 211. During operations, inner support member 120 (as well as pipelines 20, 30, and upper support member 130) are raised relative to ground 5 and outer support member 110 in the manner previously described until a desired height (e.g., height H₂₀) is achieved. To fix the relative positions of inner support member 120 and outer support member 110, the apertures 212 of one of the rows 214 in inner support member 120 are aligned both axially and circumferentially with the pair of apertures 218 extending through outer support member 110. Thereafter, body 209 of pin 210 is inserted through the aligned apertures 212, 218 along an axis 215 until head 211 engages or abuts the radially outer surface 110c of outer support member 110. In this embodiment, axis 215 extends perpendicularly to axis 105 of support assembly 200. Thus, once pin 210 is installed through support members 110, 120 in the manner described, relative movement of inner support member 120 relative to outer support member 110 is prevented by pin 210. To further secure pin 210 to support members 110, 120, pin 210 may be secured to the radially outer surface 110c of outer support member 110 after pin 210 is inserted through the aligned apertures 212, 218 as described above. Specifically, in some embodiments, head 211 of pin 210 may be welded to radially outer surface 110c. In other embodiments, an additional securing pin, such as, for example, a cotter pin (not shown), may be inserted through the portion of body 209 of pin 210 that extends beyond the radially outer surface 110c of outer support member 110, or a matching/corresponding bolt may be threadably attached to one end of pin 211. In at least some of these embodiments, the additional support pin (not shown) may extend perpendicularly through the axis 215; however, such alignment is not required. Persons of skill should understand that any such pin securement technique might be used to fix the relative positions of the inner and outer support members 120, 110, respectively. For example, an alternative embodiment might use a specialized pin with retracting extensions toward one end (which may preferably extend approximately orthogonally to the central axis 215).

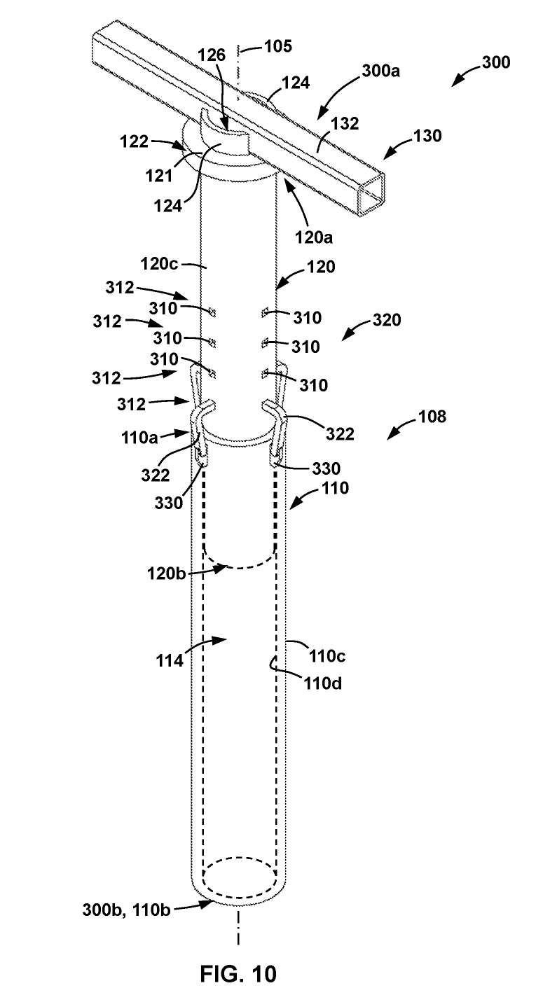

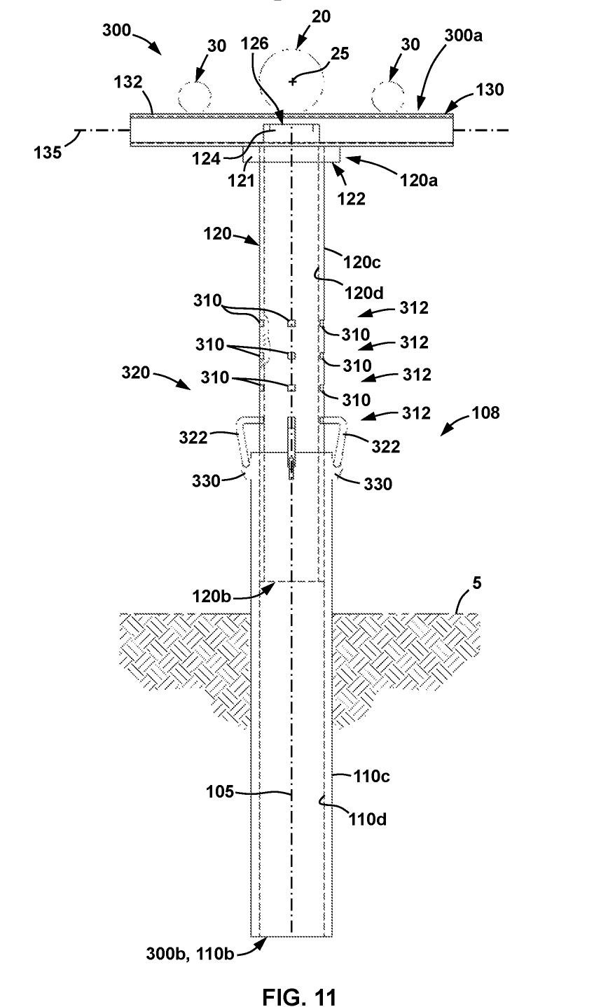

Referring now to FIGS. 10 and 11, another embodiment of support assembly 300 for supporting pipeline 20 at height H₂₀ (see FIG. 1) is shown. Support assembly 300 is substantially the same as support assembly 100, previously described, and thus, shared components between the support assemblies 100, 300 will be labeled with the same reference numerals and the description below will concentrate on the components of support assembly 300 that are different from support assembly 100. In particular, support assembly 300 includes the central axis 105, a first or upper end 300a, a second or lower end 300b opposite upper end 300a, vertical pile assembly 108, and upper support member 130. In addition, vertical pile assembly 108 may be transitioned between the retracted and extended positions shown in FIGS. 4 and 5 to raise and/or lower pipelines 20, 30 (or conduit segments thereof) relative to ground 5 as previously described.

In this embodiment, support assembly 300 does not include the weld or junction 112 to fix the axial position of inner support member 120 relative to outer support member 110 when the vertical pile assembly 108 is placed in the extended position (e.g., see FIG. 5). Rather, support assembly 300 includes a ratcheting pin assembly 320 that engages with a plurality of recesses 310 extending radially through inner support member 120. In particular, as best shown in FIG. 11, each recess 310 extends radially into the radially outer surface 120c of inner support member 120. In addition, recesses 310 are arranged in a plurality of axially spaced rows 312, with each row 312 including a total of four (4) recesses 310 that are uniformly angularly spaced from one another about axis 105 (although, in other embodiments the number of recesses 310 in each row may be greatly varied). Thus, in this embodiment, because each row 312 includes a total of four (4) recesses 310, each recess 310 is angularly spaced 90° from each immediately angularly adjacent recess 310 about axis 105 within the corresponding row 312. In some embodiments, each row 312 is axially spaced 1 foot from each axially adjacent row 312; however, the axial spacing of rows 312 may be greatly varied, and the axial spacing between rows 312 may not be uniform in some embodiments.

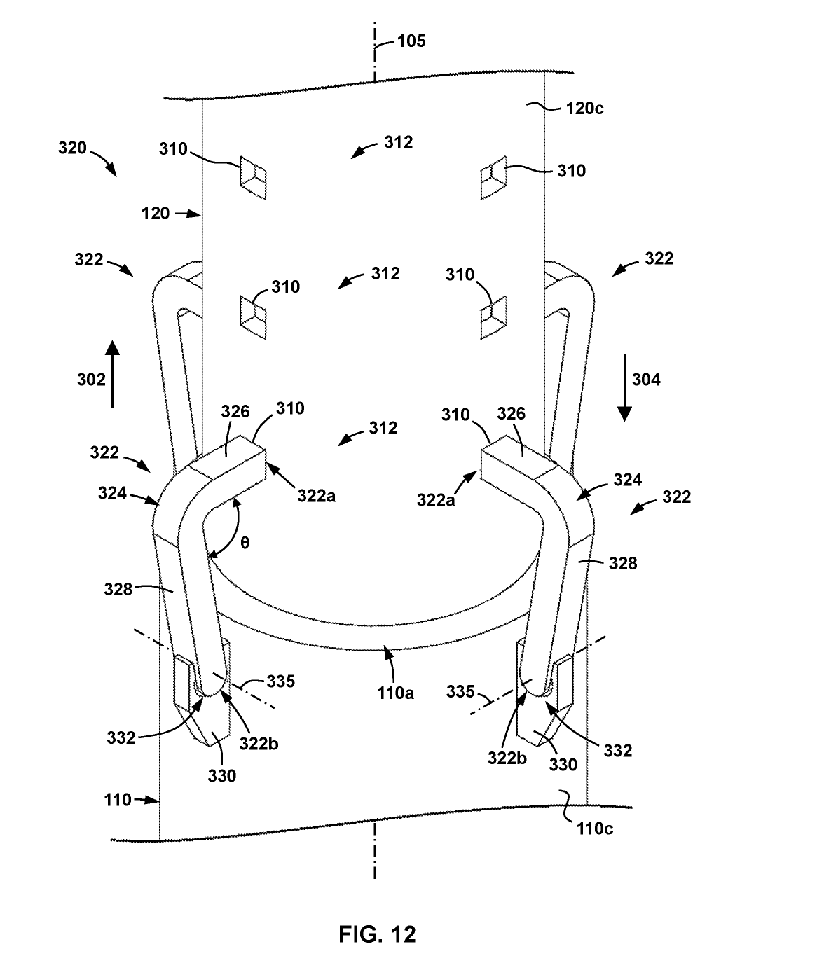

Referring now to FIG. 12, ratcheting pin assembly 320 of this embodiment includes a plurality of four (4) ratcheting pins 322 that are rotatably mounted to the radially outer surface 110c of outer support member 110 (preferably, the ratcheting pin assembly 320 includes a number of ratcheting pins 322 that matches the number of recesses 310 in each row 312 as discussed above). Ratcheting pins 322 are spaced to circumferentially align with one of the recesses 310 in each row 312. Thus, in this embodiment, each ratcheting pin 322 is angularly spaced 90° from each immediately angularly adjacent ratcheting pin 322.

Each ratcheting pin 322 includes a first end 322a, a second end 322b, and a body 324 extending between ends 322a, 322b. In this embodiment, body 324 is generally L-shaped and includes a first body member 326 extending from first end 322a, and a second body member 328 extending from the first body member 326 to the second end 322b. First body member 326 extends at an angle θ relative to second body member 328. In at least some embodiments, the angle θ may range from 90° to 130°. In other embodiments, θ may range from 110° to 130°. Second end 322b of each ratcheting pin 322 is rotatably mounted within a saddle 332 of a corresponding base member 330 disposed along radially outer surface 110c of outer support member 110. Thus, each ratcheting pin 322 may rotate about second end 322b within the corresponding saddle 332 about an axis 335 that extends parallel to a plane (not shown) passing perpendicularly through the axis 105. In addition, first end 322a of each ratcheting pin 322 is configured to be received within one of the recesses 310 extending radially into radially outer surface 120c of inner support member 120. In this embodiment, each pin 322 is rotatably biased within saddle 332 such that first end 322a is biased radially inward toward axis 105. Thus, during operation, first end 322a of ratcheting pin 322 is biased radially inward toward radially outer surface 120c and recesses 310. Pins 322 may be rotatably biased within saddles 332 through any suitable method or device, such as, for example, a torsional spring disposed between pin 322 and saddle 332. In other embodiments, the pins 322 may not be biased, and may have some other means to secure their engagement within the corresponding recesses 310 (e.g., retractable extensions as previously described).

Typically, the engagement between first end 322a of each pin 322 and the corresponding recess 310 is such that an axial translation of inner support member 120 in an upward direction (i.e., the direction of arrow 302 in FIG. 12) relative to outer support member 110 causes first end 322a to disengage from the corresponding recess 310, but an axial translation of inner member 120 in a downward direction (i.e., in the direction of arrow 304 in FIG. 12) causes first end 322a to remain engaged within the corresponding recess 310. As a result, ratcheting pin assembly 320 allows inner support member 120 to translate axially relative to outer support member 110 in direction 302, but prevents or at least restricts axial translation of inner support member 120 relative to outer support member 110 in direction 304. Various designs and embodiments are contemplated to allow for the above described functionality of ratcheting pin assembly 320. To provide further illustration, a few example embodiments are discussed below.

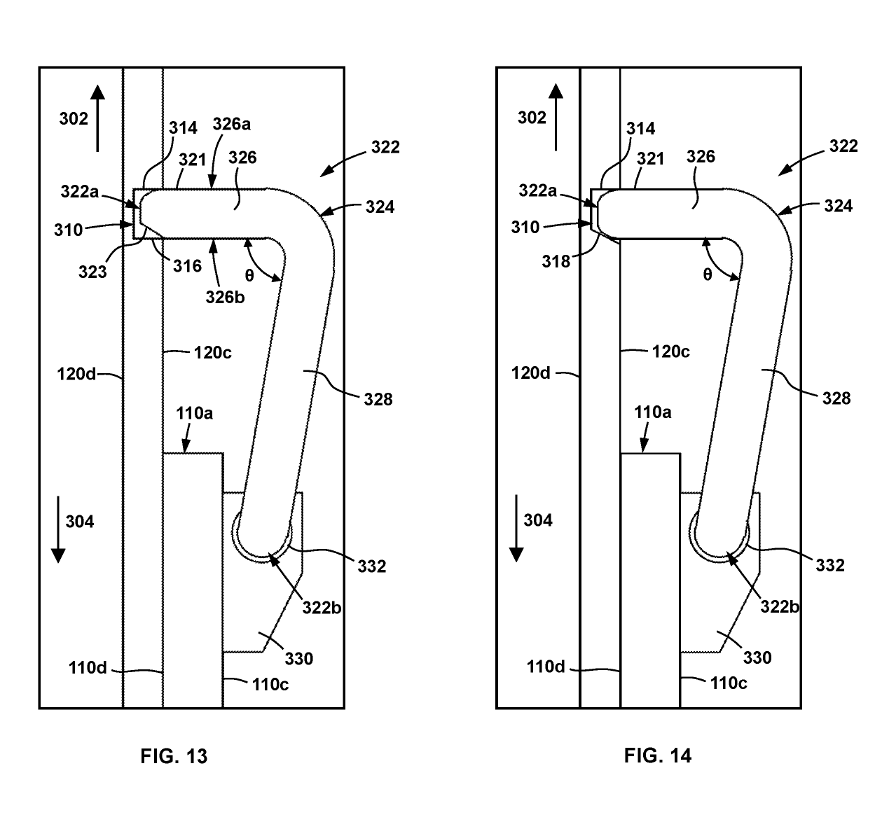

First, referring now to FIG. 13, in some embodiments, pin 322 may include a ramped surface 323 on an axially lower side 326b of first body member 326 that extends from first end 322a, and a planar engagement surface 321 on an axially upper side 326a of first body member 326. Recesses 310 (of which only one is shown in FIG. 13 for convenience) may each be formed of an axially upper radially extending planar surface 314 and an axially lower radially extending planar surface 316 (with each of the surfaces 314, 316 extending radially with respect to axis 105—see FIG. 12). When ratcheting pin 322 is inserted within recess 310, planar surface 321 of pin 322 is substantially parallel to upper surface 314 of recess 310, and ramped surface 323 of pin 322 is inclined relative to lower surface 316 of recess 310. Thereafter, an axial translation of inner support member 120 along arrow 302 causes lower planar surface 316 within recess 310 (and/or the corner between lower surface 316 and radially outer surface 120c of inner support member 120) to slidingly engage with ramped surface 323. This sliding engagement transfers a radially directed force from inner support member 120 to ratcheting pin 322 that counteracts and overcomes the rotational bias of the pin 322 and causes first end 322a of pin 322 to disengage from recess 310. Thus, inner support member 120 may freely axially traverse along direction 302. Conversely, if inner support member 120 is forced axially downward along arrow 304, planar surface 321 on an upper side of the first end 322a engages and abuts an upper surface 314 within recess 310 to prevent disengagement both of pin 322 and recess 310 and axial movement of inner support member 120 relative to outer support member 110.

Referring now to FIG. 14, as another example, rather than forming a ramped surface 323 on pins 322, each recess 310 may include the upper radially extending planar surface 314 as previously described and a lower planar ramped surface 318 that is disposed at an angle between 0° and 90° relative to a plane extending perpendicularly through axis 105. Thus, as with the embodiment of FIG. 13, once first end 322a is seated within recess 310, an axial translation of inner support member 120 along arrow 302 causes lower ramped surface 318 to slidingly engage with ramped first end 322a of pin 322. This sliding engagement transfers a radially directed force from inner support member 120 to ratcheting pin 322 that counteracts and overcomes the rotational bias of the pin 322 and cause first end 322a of pin 322 to disengage from recess 310. Thus, as with the embodiment of FIG. 13, inner support member 120 may freely axially traverse along direction 302. Conversely, if inner support member 120 is forced axially downward along arrow 304, the planar surface 321 on the upper side of the first end 322a engages and abuts an upper radial surface 314 within recess 310 to prevent both disengagement of pin 322 and recess 310 and axial movement of inner support member 120 relative to outer support member 110.

As still another example, in some embodiments, the angle θ between body members 326, 328 may be adjusted (e.g., increased) such that when first end 322a is inserted within the corresponding recess 310, the first body member 326 is oriented in a non-radial direction relative to axis 105. In particular, in these embodiments, first body member 326 may be inclined relative to central axis 105 such that first body member 326 extends at least slightly axially upward relative to the radial direction. Thus, in these embodiments, once first end 322a is seated within recess 310, an axial translation of inner support member 120 along arrow 302 causes the inclined surfaces of first body member 326 to slidingly engage with recess 310 and allows first end 322a to disengage from recess 310. Conversely, if inner support member 120 is forced axially downward along arrow 304, the first end 322a is forced into recess 310 to prevent both disengagement of pin 322 and recess 310 and axial movement of inner support member 120 relative to outer support member 110 in direction 304.

It should also be appreciated that in some of these embodiments (e.g., the embodiments of FIGS. 12-14) the first end 322a of each pin 322 may include a roller or other suitable bearing member to facilitate sliding engagement between first end 322a of pin 322 and the radially outer surface 120c of inner support member 120.

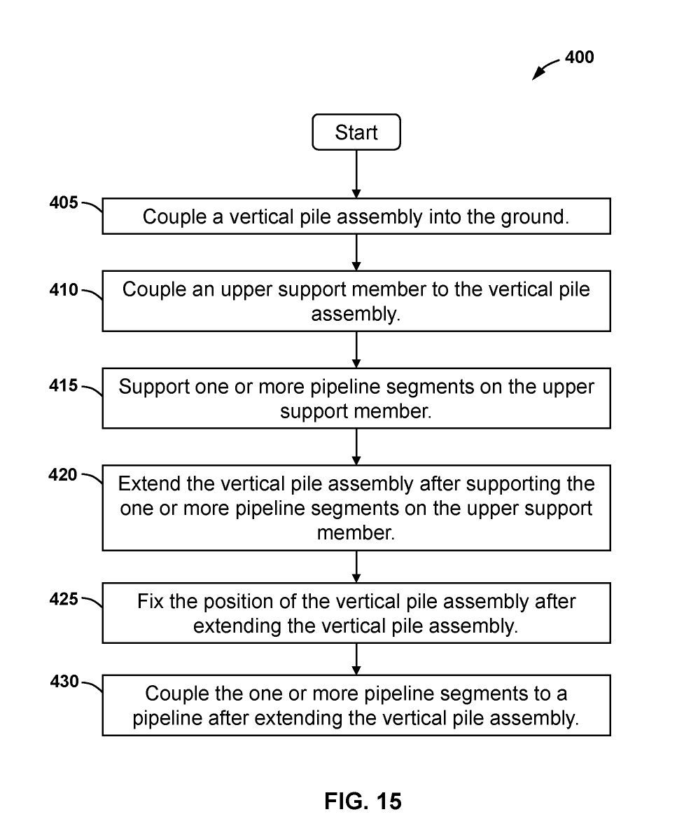

Referring now to FIG. 15, a method 400 for constructing and installing a pipeline (e.g., pipeline 20) above the ground is shown. In describing method 400, reference will be made to the components of the embodiments shown in FIGS. 1-14; however, it should be appreciated that method 400 may be performed utilizing different components and embodiments that are not specifically described herein, and any reference to the embodiments of FIGS. 1-14 is merely made out of convenience.

Initially, method 400 includes coupling a vertical pile assembly (e.g., vertical pile assembly 108) to the ground at 405. For example, as described above, for support assemblies 100, 200, 300, a first support member (e.g., outer support member 110) of vertical pile assembly 108 is inserted and secured within the ground in the manner described above. Specifically, the first support member may be driven into the ground and secured therein through a friction fit. Also, the first support member may be inserted within an oversized hole in the ground and secured therein by filling the space between the hole and the first support member with a sand and slurry mixture (e.g., for permafrost soils) or cement which then hardens (e.g., freezes, dries, etc.) in place. In addition, method 400 may also include placing a second support member (e.g., the inner support member 120) in axial sliding engagement within the first support member (e.g., outer support member 110) either before or after inserting and securing the first support member within the ground.

Method 400 also includes coupling an upper support member to the vertical pile assembly at 410. For example, as described above for support assemblies 100, 200, 300, an upper support member (e.g., upper support member 130) is mounted to an upper end (e.g., upper end 120a) of a support member (e.g., inner support member 120) of the vertical pile assembly (e.g., vertical pile assembly 108). In other embodiments, however, the upper support member may be coupled to another portion of the vertical support assembly other than the upper end of one of the support members. The upper support member may include at least one support surface (e.g., surface 132) configured to support one or more pipelines (e.g., pipelines 20, 30) thereon.

Method 400 also includes supporting one or more pipeline segments (e.g., segments 22) on the upper support member at 415. Preferably, the one or more pipeline segments are installed on the upper support member after the upper support member is coupled to the vertical pile assembly in 410. In some embodiments, installing the one or more pipelines on the upper support member in 415 includes installing the one or more pipelines into one or more saddles on the upper support member (e.g., with the one or more saddles being secured to the upper support member). In addition, in some embodiments, installing the one or more pipeline segments on the upper support member in 415 includes installing a complete (or nearly complete) pipeline (or pipelines) onto the upper support member.

Next, method 400 includes extending the vertical pile assembly at 420. The lifting in 420 is carried out after supporting the one or more pipeline segments on the upper support member at or near the ground (e.g., 4-8 feet from the ground) in 415. In particular, as described for the vertical pile assembly 108 of support assemblies 100, 200, 300, the extending in 420 may comprise extending an inner support member (e.g., inner support member 120) from a throughbore (e.g., throughbore 114) of an outer support member (e.g., outer support member 110) (e.g., such as shown in the transition from the retracted position of FIG. 4 to the extended position of FIG. 5). In addition, in some embodiments, the extending in 420 may be accomplished by utilizing one or more jacks (e.g., jacks 140 shown in FIG. 6) that bear against the upper support member and the ground (or some other support surface or member). In still other embodiments, the extending in 420 may be accomplished by tensioning a cable or line (e.g., lines 148 shown in FIG. 7) that are attached to one or more of the pipelines, upper support member, the inner support member (e.g., member 120) of the vertical pile assembly, or another component coupled thereto (e.g., support flange 121).

Next, method 400 includes fixing the position of the vertical pile assembly at 425. The fixing in 425 may be accomplished through any suitable method or device. For example, as described above for the support assembly 100, the extended position of the vertical pile assembly 108 is fixed by placing a weld or junction (e.g., weld 112) between a first support member (e.g., outer support member 110) and a second support member (e.g., inner support member 120). As another example, as described above for the support assembly 200, in some embodiments, the fixing in 425 is achieved by placing a pin (e.g., pin 210 shown in FIGS. 8 and 9) through each of a first support member (e.g., outer support member 110) and a second support member (e.g., inner support member 120) after a pair of apertures in the first and second support members (e.g., apertures 212, 218) are aligned by extending the vertical pile assembly (e.g., assembly 108) in 420. As still another example, as described for support assembly 300, in some embodiments, the fixing in 425 is achieved with a ratcheting pin assembly (e.g., assembly 320 shown in FIGS. 10-14) that includes one or more pins that are biased into an engagement with a plurality of axially spaced recesses (e.g., recesses 310) in a second support member (e.g., inner support member 120) to selectively restrict movement of the second support member relative to a first support member (e.g., outer support member 110) in a first direction, but freely allow movement of the second support member relative to the first support member in a second direction that is opposite the first direction.

Finally, method 400 includes coupling the one or more pipeline segments to a pipeline after extending the vertical pile assembly in 420 at 430. For example, the one or more pipeline segments (e.g., segments 22) may be welded, bolted, or otherwise secure to other similar segments that make up the rest of the pipeline (e.g., pipeline 20).

In the manner described, through use of a support assembly for elevating and supporting a pipeline (e.g., pipelines 20, 30) at a desired height (e.g., height H₂₀) above the ground in accordance with the embodiments disclosed herein, an elevated pipeline (or segments thereof) may be initially constructed close to ground level and then raised to the desired height thereafter. In addition, in some embodiments, the pipeline may also be lowered by retraction of the vertical pile assemblies (e.g., assembly 108) of the disclosed support assemblies for maintenance and/or decommissioning. Thus, through use of a support assembly as described herein, these pipeline construction and maintenance operations can be carried out with a higher degree of safety and simplicity than was previously possible. In addition, through use of a support assembly in accordance with the embodiments disclosed herein, fewer lifting devices (or smaller lifting devices) may be used to accomplish such pipeline construction and maintenance operations thereby reducing the costs associated therewith. Further, through use of a support assembly in accordance with the embodiments disclosed herein, a locking mechanism (e.g., weld 112, pin 210, ratcheting pin assembly 320) may be used to fix the vertical pile assembly (e.g., assembly 108) in the extended position and prevent transition of the vertical pile assembly from the extended position to the retracted position.

Having described above various embodiments (especially those in the figures), various additional embodiments may include, but are not limited to the following:

In a first embodiment a support assembly for supporting a pipeline at a height above the ground, the support assembly having a central axis and comprising: a vertical pile assembly configured to be coupled to the ground; and an upper support member coupled to the vertical pile assembly, wherein the upper support member includes a support surface that is configured to support one or more pipelines; wherein the vertical pile assembly is configured to transition between a retracted position, wherein the support surface is disposed at a height H1 measured axially from the ground, and an extended position, wherein the support surface is disposed at a height H2 measured axially from the ground that is greater than the height H1. In a second embodiment, the elements of the first embodiment and further comprising a locking mechanism configured to fix the vertical pile assembly in the extended position. In a third embodiment, the elements of embodiments 1-2, wherein the vertical pile assembly comprises: a first support member including an axially extending throughbore; and a second support member at least partially disposed within the throughbore, wherein the upper support member is coupled to an upper end of the second support member; wherein when the vertical pile assembly is transitioned from the retracted position to the extended position, the second support member is extended axially from the throughbore. In a fourth embodiment, the elements of the third embodiment and further comprising a locking mechanism configured to fix a position of the second support member relative to the first support member when the vertical pile assembly is in the extended position. In a fifth embodiment, the elements of the fourth embodiment wherein the locking mechanism comprises weld between the second support member and the first support member. In a sixth embodiment, the elements of embodiments 4-5 wherein: the first support member includes a first aperture; the second support member includes a second aperture; when the vertical pile assembly is in the extended position, the first aperture is aligned with the second aperture; and the locking mechanism comprises a pin configured to be inserted through the first aperture and the second aperture when the vertical pile assembly is in the extended position. In a seventh embodiment, the elements of embodiments 4-6 wherein the second support member includes a radially outer surface and a recess extending radially inward from the radially outer surface; the locking mechanism comprises a ratcheting pin assembly comprising a ratcheting pin including a first end and a second end distal the first end; the second end of the ratcheting pin is rotatably coupled to the first support member; the first end of the ratcheting pin is configured to be received within the recess; and the first end of the ratcheting pin is biased radially inward toward the central axis. In an eighth embodiment, the elements of the seventh embodiment, wherein the ratcheting pin assembly is configured such that an axial movement of the second support member in a first direction causes the first end of the ratcheting pin to disengage from the recess, and an axial movement of the second support member in a second direction that is opposite the first direction causes the first end of the ratcheting pin to engage within the recess.

In a ninth embodiment, a piping system, comprises a pipeline including a continuous flow path configured to receive and flow a fluid therethrough; a plurality of support assemblies coupled to the pipeline and configured to support the pipeline at a height above the ground; wherein each support assembly includes a central axis and comprises: a vertical pile assembly coupled to the ground; and an upper support member coupled to the vertical pile assembly, wherein the upper support member includes a support surface that is configured to support the pipeline; wherein the vertical pile assembly is configured to transition between a retracted position, wherein the support surface is disposed at a height H1 measured axially from the ground, and an extended position, wherein the support surface is disposed at a height H2 measured axially from the ground that is greater than the height H1. In a tenth embodiment, the elements of the ninth embodiment wherein each support assembly further comprises a locking mechanism configured to fix the vertical pile assembly in the extended position. In an eleventh embodiment, the elements of embodiments 9-10 wherein the vertical pile assembly of each support assembly comprises: a first support member including an axially extending throughbore; and a second support member at least partially disposed within the throughbore, wherein the upper support member is coupled to an upper end of the second support member, wherein when the vertical pile assembly is transitioned from the retracted position to the extended position, the second support member is extended axially from the throughbore. In a twelfth embodiment, the elements of the eleventh embodiment wherein each support assembly further comprises a locking mechanism configured to fix a position of the second support member relative to the first support member when the vertical pile assembly is in the extended position. In a thirteenth embodiment, the elements of embodiments 10-12 wherein the locking mechanism of each support assembly comprises weld between the inner support member and the outer support member. In a fourteenth embodiment, the elements of embodiments 12-13 wherein for each support assembly: the first support member includes a first aperture; the second support member includes a second aperture; when the vertical pile assembly is in the extended position, the first aperture is aligned with the second aperture; and the locking mechanism comprises a pin configured to be inserted through the first aperture and the second aperture when the vertical pile assembly is in the extended position. In a fifteenth embodiment, the elements of embodiments 12-14 wherein for each support assembly: the second support member includes a radially outer surface and a recess extending radially inward from the radially outer surface; the locking mechanism comprises a ratcheting pin assembly comprising a ratcheting pin including a first end and a second end distal the first end; the second end of the ratcheting pin is rotatably coupled to the first support member; the first end of the ratcheting pin is configured to be received within the recess; and the first end of the ratcheting pin is biased radially inward toward the central axis. In a sixteenth embodiment, the elements of the fifteenth embodiment wherein the ratcheting pin assembly of each support assembly is configured such that an axial movement of the second support member in a first direction causes the first end of the ratcheting pin to disengage from the recess, and an axial movement of the second support member in a second direction that is opposite the first direction causes the first end of the ratcheting pin to engage within the recess.

In a seventeenth embodiment a method for installing an elevated pipeline at a desired height above the ground comprises: (a) coupling a vertical pile assembly to the ground, the vertical pile assembly extending along a central axis and being configured for extension along the central axis; (b) coupling an upper support member to the vertical pile assembly, the upper support member including a support surface; (c) supporting a conduit segment of the pipeline on the support surface; and (d) extending the vertical pile assembly along the axis after (c). In an eighteenth embodiment, the elements of the seventeenth embodiment wherein (a) comprises: (a1) inserting an outer support member of the vertical pile assembly into the ground; and (a2) inserting an inner support member of the vertical pile assembly into an axially extending throughbore in the outer support member; and wherein (b) comprises coupling the upper support member to an upper end of the inner support member. In a nineteenth embodiment, the elements of embodiments 17-18 wherein (d) comprises: (d1) coupling a plunger of a jack to the upper support member, the plunger at least partially disposed within a housing along a jack axis, wherein the jack axis is parallel and radially offset from the central axis; and (d2) extending the plunger from the housing along the jack axis. In a twentieth embodiment, the elements of embodiments 17-19 wherein (d) comprises: (d1) coupling a line extending from a lifting device to an inner support member of the vertical pile assembly; and (d2) applying tension to the line with the lifting device. In a twenty-first embodiment, the elements of embodiments 17-20 and further comprising coupling the conduit segment to the pipeline after (d). In a twenty-second embodiment, the elements of embodiments 17-21 and further comprising fixing a position of the vertical pile assembly after (d).

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, while embodiments disclosed herein have included a single inner support member 120 that is telescopically movable relative to an outer support member 110, it should be appreciated that in other embodiments, one or more intermediate support members may be disposed between the outer support member 110 and the inner support member 120 such that transitioning the support assembly (e.g., support assembles 100, 200, 300) from the retracted position to the extended position includes moving or translating both the inner support member 120 and the intermediate support member(s) telescopically out of the outer support member 110 along axis 105. As another example, while each support assembly (e.g., support assemblies 100, 200, 300) have been shown and described as including only one telescoping set of outer and inner support members 110, 120 coupled to the upper support member 130, it should be appreciated that in other embodiments, each support assembly (e.g., assemblies 100, 200, 300) may include more than one set of outer and inner support members 110, 120 arranged parallel to one another and coupled to the upper support member. As still another example, while the support assemblies 100, 200, 300 have been described as including a vertical pile assembly 108 that includes one support member (e.g., support member 120) that extends from a throughbore (e.g., throughbore 114) extending within another support member (e.g., support member 110), it should be appreciated that in other embodiments, one support member may be coupled to the other support member such that one of the support members is movable relative to the other support member in an axial direction (either along a common axis or parallel axes), but neither of the support members is necessarily inserted within the other (e.g., the support member 120 may be slidably coupled along a side of the support member 110 rather than being inserted within throughbore 114).

Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps. In addition, in the claims, any designation of a claim as depending from a range of claims (for example #-##) would indicate that the claim is a multiple dependent claim based of any claim in the range (e.g. dependent on claim # or claim ## or any claim therebetween). Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A support assembly for supporting a pipeline at a height above the ground, the support assembly having a central axis and comprising:
a vertical pile assembly configured to be coupled to the ground; and
an upper support member coupled to the vertical pile assembly, wherein the upper support member includes a support surface that is configured to support one or more pipelines;
wherein the vertical pile assembly is configured to transition between a retracted position, wherein the support surface is disposed at a height H1 measured axially from the ground, and an extended position, wherein the support surface is disposed at a height H2 measured axially from the ground that is greater than the height H1.

2. The support assembly of claim 1, further comprising a locking mechanism configured to fix the vertical pile assembly in the extended position.

3. The support assembly of claim 1, wherein the vertical pile assembly comprises:
a first support member including an axially extending throughbore; and
a second support member at least partially disposed within the throughbore, wherein the upper support member is coupled to an upper end of the second support member;
wherein when the vertical pile assembly is transitioned from the retracted position to the extended position, the second support member is extended axially from the throughbore.

4. The support assembly of claim 3, further comprising a locking mechanism configured to fix a position of the second support member relative to the first support member when the vertical pile assembly is in the extended position.

5. The support assembly of claim 4, wherein the locking mechanism comprises weld between the second support member and the first support member.

6. The support assembly of claim 4, wherein:
the first support member includes a first aperture;
the second support member includes a second aperture;
when the vertical pile assembly is in the extended position, the first aperture is aligned with the second aperture; and
the locking mechanism comprises a pin configured to be inserted through the first aperture and the second aperture when the vertical pile assembly is in the extended position.

7. The support assembly of claim 4, wherein:
the second support member includes a radially outer surface and a recess extending radially inward from the radially outer surface;
the locking mechanism comprises a ratcheting pin assembly comprising a ratcheting pin including a first end and a second end distal the first end;
the second end of the ratcheting pin is rotatably coupled to the first support member;
the first end of the ratcheting pin is configured to be received within the recess; and
the first end of the ratcheting pin is biased radially inward toward the central axis.

8. The support assembly of claim 7, wherein the ratcheting pin assembly is configured such that an axial movement of the second support member in a first direction causes the first end of the ratcheting pin to disengage from the recess, and an axial movement of the second support member in a second direction that is opposite the first direction causes the first end of the ratcheting pin to engage within the recess.

9. A piping system, comprising:
a pipeline including a continuous flow path configured to receive and flow a fluid therethrough;
a plurality of support assemblies coupled to the pipeline and configured to support the pipeline at a height above the ground;
wherein each support assembly includes a central axis and comprises:
a vertical pile assembly coupled to the ground; and
an upper support member coupled to the vertical pile assembly, wherein the upper support member includes a support surface that is configured to support the pipeline;
wherein the vertical pile assembly is configured to transition between a retracted position, wherein the support surface is disposed at a height H1 measured axially from the ground, and an extended position, wherein the support surface is disposed at a height H2 measured axially from the ground that is greater than the height H1.

10. The piping system of claim 9, wherein each support assembly further comprises a locking mechanism configured to fix the vertical pile assembly in the extended position.

11. The piping system of claim 9, wherein the vertical pile assembly of each support assembly comprises:
a first support member including an axially extending throughbore;
a second support member at least partially disposed within the throughbore, wherein the upper support member is coupled to an upper end of the second support member;
wherein when the vertical pile assembly is transitioned from the retracted position to the extended position, the second support member is extended axially from the throughbore; and
a locking mechanism configured to fix a position of the second support member relative to the first support member when the vertical pile assembly is in the extended position.

12. The piping system of claim 11, wherein the locking mechanism of each support assembly comprises weld between the inner support member and the outer support member.

13. The piping system of claim 11, wherein for each support assembly:
the first support member includes a first aperture;
the second support member includes a second aperture;
when the vertical pile assembly is in the extended position, the first aperture is aligned with the second aperture; and
the locking mechanism comprises a pin configured to be inserted through the first aperture and the second aperture when the vertical pile assembly is in the extended position.

14. The piping system of claim 11,
wherein for each support assembly:
the second support member includes a radially outer surface and a recess extending radially inward from the radially outer surface;
the locking mechanism comprises a ratcheting pin assembly comprising a ratcheting pin including a first end and a second end distal the first end;
the second end of the ratcheting pin is rotatably coupled to the first support member;
the first end of the ratcheting pin is configured to be received within the recess;
the first end of the ratcheting pin is biased radially inward toward the central axis; and
wherein the ratcheting pin assembly of each support assembly is configured such that an axial movement of the second support member in a first direction causes the first end of the ratcheting pin to disengage from the recess, and an axial movement of the second support member in a second direction that is opposite the first direction causes the first end of the ratcheting pin to engage within the recess.

15. A method for installing an elevated pipeline at a desired height above the ground, the method comprising:
(a) coupling a vertical pile assembly to the ground, the vertical pile assembly extending along a central axis and being configured for extension along the central axis;
(b) coupling an upper support member to the vertical pile assembly, the upper support member including a support surface;
(c) supporting a conduit segment of the pipeline on the support surface; and
(d) extending the vertical pile assembly along the axis after (c).

16. The method of claim 15,
wherein (a) comprises:
(a1) inserting an outer support member of the vertical pile assembly into the ground; and
(a2) inserting an inner support member of the vertical pile assembly into an axially extending throughbore in the outer support member; and
wherein (b) comprises coupling the upper support member to an upper end of the inner support member.

17. The method of claim 15, wherein (d) comprises:
(d1) coupling a plunger of a jack to the upper support member, the plunger at least partially disposed within a housing along a jack axis, wherein the jack axis is parallel and radially offset from the central axis; and
(d2) extending the plunger from the housing along the jack axis.

18. The method of claim 15, wherein (d) comprises:
(d1) coupling a line extending from a lifting device to an inner support member of the vertical pile assembly; and
(d2) applying tension to the line with the lifting device.

19. The method of claim 15, further comprising coupling the conduit segment to the pipeline after (d).

20. The method of claim 15, further comprising fixing a position of the vertical pile assembly after (d).
